(19) United States
(12) Patent Application Publication
(10) Pub. No.: US 2020/0036559 A1
(43) Pub. Date: Jan. 30, 2020

(54) INTRINSICALLY SAFE ENERGY AND DATA TRANSMISSION IN AN ETHERNET NETWORK

(71) Applicants: SIEMENS AKTIENGESELLSCHAFT, Munchen (DE); ABB SCHWEIZ AG, Baden (CH)

(72) Inventors: Jens Gottron, Karlsruhe (DE); MANFRED KAISER, Kunzelsau (DE); DIETMAR OVERHOFF, Hosbach (DE); JORG STRITZELBERGER, Ohringen (DE); CHRISTOPH WEILER, Bretten (DE)

(21) Appl. No.: 15/735,081

(22) PCT Filed: Jun. 6, 2016
(86) PCT No.: PCT/EP2016/062739

§ 371 Date: Dec. 8, 2017

(30) Foreign Application Priority Data
Jun. 10, 2015 (DE) 10 2015 210 628.4

(51) Int. Cl. H04L 25/02; H04L 12/10; H04L 12/40

(52) U.S. Cl. CPC H04L 25/0266; H04L 12/40136; H04L 12/10; H04L 25/0276

(57) ABSTRACT

A transmission device for the intrinsically safe transmission of data in an Ethernet network via a core pair of an Ethernet cable is disclosed. The transmission device includes a first sub-path connected to a first wire of the core pair of an Ethernet signal pair and a second sub-path connected to a second wire of the core pair of the Ethernet signal pair. Each sub-path comprises at least one current-limiting resistor and a common-mode rejection unit connected in series to the current-limiting resistor.

The invention relates to a transmission device for intrinsically safe data transmission in an Ethernet network, an Ethernet network having at least one network device arranged in an explosion-hazardous environment, and a method for intrinsically safe data transmission in such an Ethernet network.

In particular, the invention relates to networks to enable process automation in explosion-hazardous environments. In the process automation field, a particular objective involves providing process parameters such as pressure, temperature, flow rate or level across widely distributed systems in an automation system. In explosion-hazardous areas, field devices and sensors are currently connected to low-performance digital interfaces such as Profibus PA (Process Field Bus Process Automation) or HART (Highway Addressable Remote Transducer) or to analog interfaces for current amplitudes of approximately 4 mA to 20 mA. These systems allow a simple connection technology with two conductors, i.e. power and data are transmitted over the same pair of conductors. Depending on the system, large distances with lengths of up to or even greater than 1000 m can be covered. These systems are protected according to the protection class known as “Intrinsic safety”. Connected devices can be replaced or connected during operation.

The requirements of the “Intrinsic safety” explosion protection class severely restrict the above-mentioned Profibus PA and HART bus systems with regard to their supply of power and their data rate. Analog interfaces for current amplitudes of approximately 4 mA to 20 mA only allow transmission of measurements but not additional data, such as diagnostic parameters. The data transmission power is limited to a few milliwatts. By expanding the system with HART, some diagnostic functions can be implemented with a data rate in the single-digit kilobit range. Profibus PA offers a data rate in the double-digit kilobit range, but this must be shared between several nodes on the bus. The available power must also be shared by all nodes on the bus. The intrinsic safety of the Profibus-PA system must be demonstrated for each individual case, and this proof can sometimes be complicated.

For performance-intensive applications the power provided is not sufficient and additional energy must be provided, so that the connection is made over four wires. A different type of protection for the energy transmission must then be selected, e.g. Ex-e. Modern, high-performance devices which have a web server, for example, require a connection to a communication interface with the appropriate performance and data rate.

In non-explosion-hazardous environments, Ethernet has established itself as a standard for communication in networks. For applications with simultaneous transmission of data and power, the standard known as “Power over Ethernet” is available. However, there are no standards in the field of intrinsically safe Ethernet.

The object of the invention is to specify a transmission device for intrinsically safe data transmission in an Ethernet network, an Ethernet network having at least one network device arranged in an explosion-hazardous environment, and a method for intrinsically safe data transmission in such an Ethernet network.

The object is achieved according to the invention with regard to the transmission device by the features of claim 1, with regard to the Ethernet network by the features of claim 7 and with regard to the method by the features of claim 9.

Advantageous configurations of the invention are the subject matter of the dependent claims.

A transmission device according to the invention is provided for intrinsically safe data transmission in an Ethernet network via a core pair of an Ethernet cable. For this purpose, the transmission device comprises a first sub-path of an Ethernet signal pair connected to a first core of the core pair, and a second sub-path of the Ethernet signal pair connected to the second core of the core pair. Each sub-path has at least one current-limiting resistor and a common-mode rejection unit, which is connected in series with the current-limiting resistor.

Each common mode rejection unit is preferably designed as a winding assembly, which has one of two choke windings of a current-compensated choke and two diode current branches connected in parallel with the choke winding. The two diode current branches of each winding assembly each have at least one diode, so that the two diode current branches have different blocking directions for electric current.

The common mode rejection units thus replace an Ethernet transmitter of a corresponding conventional Ethernet transmission device, which is designed as a transformer. In the implementation of the common-mode rejection units as a winding assembly, the current-compensated choke, the two choke windings of which each belong to one of the two winding assemblies, enable a common mode rejection of the signals transmitted over the two cores. The diode branches connected in parallel to the choke windings ensure that the choke does not cause any inductance that conflicts with the intrinsic safety. The diodes of the diode branches are chosen in such a way that their junction capacitances do not significantly affect the common mode rejection by the choke.

A standard Ethernet transmitter designed as a transformer could also be wired in an intrinsically safe manner using diodes, however, the junction capacitances of the diodes would seriously impair the Ethernet signal itself. On the other hand, by connecting the diodes in series with the signal in parallel with the current-compensated choke, the signal remains unaffected.

One design of the invention provides that each sub-path has at least one isolating capacitor, which is connected in series with the common-mode rejection unit and the at least one current-limiting resistor of the sub-path.

The isolating capacitors thus implement galvanic isolation in the two sub-paths of the conductor pair, which in the standard Ethernet implementation is effected by the Ethernet transmitter designed as a transformer. A voltage-limiting function using diodes (in this case Zener diodes) is not possible in this case, because the diodes would counteract the galvanic isolation. Therefore, the size of the capacitances of the isolating capacitors is critical for implementing the intrinsic safety, since the isolating capacitors act as static energy accumulators in the circuit.

Therefore, a further configuration of the invention provides that each isolating capacitor has a capacitance, so that the data transfer is intrinsically safe and a signal flow of the data transmission is not obstructed by an impedance of the isolating capacitor, so that the data transmission functions properly.

A further configuration of the invention provides that each sub-path of the conductor pair is connected to a coupling coil, via which electrical energy can be coupled into the core connected to the sub-path or decoupled out of said core.

This configuration of the invention relates specifically to Ethernet connections by means of which, as in “Power over Ethernet”, electrical energy is also transmitted over wires of an Ethernet cable in addition to data, to supply power for a network device. The energy in this case is coupled in using the coupling coils. The inductances of the coupling coils are essential for the intrinsic safety of the data transmission, since the coupling coils act as static energy accumulators in the circuit. The inductances of the coupling coils cannot be limited by diodes connected in parallel, since the diodes would substantially impair the signal. The inductances of the coupling coils required for intrinsic safety depend on the data rate of the data to be transmitted. The lower this data rate is, the higher the inductances of the coupling coils must be.

Accordingly, a further development of the invention provides that each coupling coil has an inductance that is not less than a minimum inductance, so that the coupling coil does not load data signals to be transmitted. At the same time, the inductance must not exceed a maximum value, in order to ensure the intrinsic safety of the connection.

In standard Ethernet networks, it is provided that prior to a data transmission between them, by means of a process known as auto-negotiation, two network devices connected to one another negotiate the details of the data transfer, such as the data rate or the number of cores used for the data transmission. During the auto-negotiation, data are exchanged between the two network devices at a very low data rate, which would require correspondingly high inductances of the coupling coils to obtain intrinsic safety. The invention therefore provides that in the case of a simultaneous transmission of data and power over a pair of cores of an Ethernet cable, no auto-negotiation takes place between the two participating network devices and the inductance of the coupling coils is matched to the lowest data rate of data to be transmitted over the core pair.

Accordingly, a further configuration of the invention provides that each coupling coil has an inductance which depends on a data rate of the data to be transmitted over the core pair, so that the transmission of data and power is intrinsically safe, wherein no transmission of data is provided for an auto-negotiation. The auto-negotiation algorithm can be omitted, because in the configuration with simultaneous supply of power via the core pair the communication partners, namely the supplying and supplied assembly, remain fixed. For this design the parameters of the communication are defined and preset. The requirements placed on the system ensure that a sufficiently high data rate is guaranteed, so that the coupling coils cannot exert any damaging loading of the data signal.

An Ethernet network according to the invention comprises at least one network device arranged in an explosion-hazardous environment, which is electrically connected to a core pair of an Ethernet cable by means of a transmission device according to the invention.

The basic structure of a classical Ethernet network is in this case not affected. The structure consisting of MAC layer (Media Access Control Layer) and fully transparent Ethernet interfaces (Ethernet PHY) is maintained. All mechanisms, such as addressing and bus access methods of the classical Ethernet system, including the frame contents, also remain unchanged. On the OSI layer 2 level (OSI=Open Systems Interconnection model) the deviation from Ethernet IEEE802.3 (IEEE=Institute of Electrical and Electronics Engineers) is not visible. The modifications compared to conventional Ethernet relate only to the OSI layer 1 level.

Preferably, each pair of cores of an Ethernet cable, over the cores of which only data are transmitted between a network device arranged in an explosion-hazardous environment and another network device, is connected to each of the two network devices, in each case using a transmission device according to the invention that does not have a coupling coil.

In addition, each pair of cores of an Ethernet cable, over the cores of which data and electrical energy are transmitted between a network device arranged in an explosion-hazardous environment and another network device, is preferably connected to each of the two network devices, in each case using a transmission device according to the invention which has a coupling coil for each core.

Preferably, the Ethernet network also has a BroadR-Reach functionality and/or a long-distance Ethernet functionality and/or a 2-wire Ethernet functionality. This advantageously enables intrinsically safe Ethernet networks with long ranges to be implemented.

In the method according to the invention for intrinsically safe data transmission in an Ethernet network according to the invention, there is no core pair over which data are transmitted for an auto-negotiation by means of a transmission device which has a coupling coil for each core of the pair. In addition, a minimum data rate is preferably applied and there is no core pair which is connected to a network device by means of a transmission device in accordance with claim 5 or 6, over which data are transmitted at a data rate less than the minimum data rate.

The intrinsic safety of an Ethernet network is achieved in accordance with the invention by the fact that for Ethernet connections which are to be designed intrinsically safe, two different types of transmission devices are used, namely one type over which only data are transmitted, and another type, over which electrical energy is also transmitted.

At the same time, for Ethernet connections with power supply a minimum data rate for data transmission is preferably provided, to which the transmission devices are matched. In particular, no auto-negotiation takes place over these Ethernet connections, because the interconnected communication partners, namely the supplying and supplied module for which the parameters of the communication are defined and preset, are fixed so that no auto-negotiation is needed and a sufficiently high data rate is ensured.

The properties, features and, advantages of the present invention described above and the manner in which these are achieved will become clearer and more comprehensible in conjunction with the following description of exemplary embodiments, which are explained in more detail in connection with the drawings. These show:

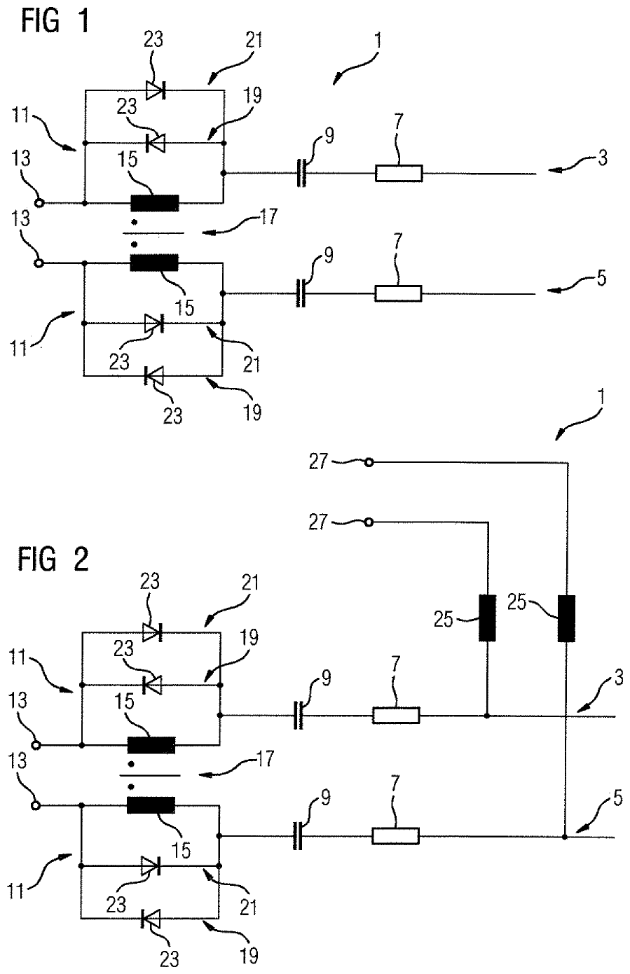

FIG. 1 a block diagram of a first exemplary embodiment of a transmission device for intrinsically safe data transmission in an Ethernet network,

FIG. 2 a block diagram of a second exemplary embodiment of a transmission device for intrinsically safe data transmission in an Ethernet network, and

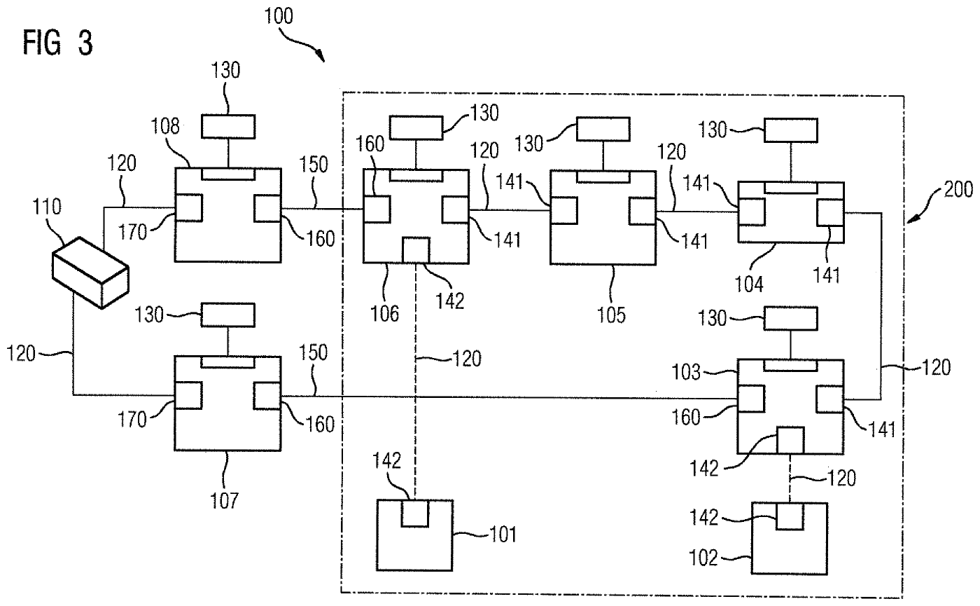

FIG. 3 a block diagram of an Ethernet network.

Equivalent parts are provided with the same reference labels in all figures.

FIG. 1 shows a block diagram of a first exemplary embodiment of a transmission device 1 for intrinsically safe data transmission in an Ethernet network 100 (see FIG. 3) over a core pair (not shown) of an Ethernet cable 120 (see FIG. 3).

The transmission device 1 has two sub-paths 3, 5 of a conductor pair. A first sub-path 3 is connected to a first core of the core pair, which is connected to the end of the first sub-path 3, shown on the right in FIG. 1. The second sub-path 5 is connected to the second core of the core pair, which is connected to the end of the second sub-path 5, shown on the right in FIG. 1.

Each sub-path part 3, 5, has a current-limiting resistor 7, an isolating capacitor 9 connected in series with the current-limiting resistor 7, a common-mode rejection unit 11 which is connected in series with the current-limiting resistor 7 and the isolating capacitor 9 and is designed as a winding assembly, and a transceiver connection 13, via which the sub-path 3, 5 can be connected to a transceiver (not shown).

Each winding module has one of two choke windings 15 of a current-compensated choke 17, and two diode current branches 19, 21 connected in parallel with the choke winding 15. The two diode current branches 19, 21 of each winding assembly each have at least one diode 23, so that the two diode current branches 19, 21 have different blocking directions for electric current.

The choke windings 15 each have, for example, an inductance of 470 μH. The isolating capacitors 9 each have, for example, a capacitance of 1.1 μF.

FIG. 2 shows a block diagram of a second exemplary embodiment of a transmission device 1 for intrinsically safe data transmission in an Ethernet network 100 (see FIG. 3) over a core pair (not shown) of an Ethernet cable 120 (see FIG. 3). This exemplary embodiment differs from the exemplary embodiment shown in FIG. 1 essentially in the fact that each sub-path 3, 5 is connected to a coupling coil 25 and a coupling connection 27, via which electrical energy, which is transmitted over the core of the core pair in addition to data signals, can be coupled in or out. If electrical energy is decoupled via the coupling coils 25 and coupling connections 27, a decoupling diode is also connected between each coupling coil 25 and the coupling connection 27.

The choke windings 15 each have, for example, an inductance of 470 μH. The isolating capacitors 9 each have, for example, a capacitance of 11 nF, The coupling coils 25 each have, for example, an inductance of 10 μH.

Other exemplary embodiments of transmission devices 1, in contrast to the transmission devices 1 shown in FIGS. 1 and 2, have instead of one diode 23 in each diode current branch 19, 21 at least two parallel-connected diodes 23, and/or instead of one isolating capacitor 9 in each sub-path 3, 5 at least two isolating capacitors connected in series 9. In this case, the diodes 23 of a diode current branch 19, 21 and the isolating capacitors 9 of a sub-path 3, 5 are each designed to be identical (redundant). Such transmission devices 1 are preferably used in explosion-hazardous environments where an appropriate redundancy of diodes 23 and/or isolating capacitors 9 is required, for example due to regulations for the devices used in these explosion-hazardous environments.

FIG. 3 shows a block diagram of an Ethernet network 100 having a plurality of network devices 101 to 108, which belong to an automation system, for example. Six network devices 101 to 106, which can be arranged in an explosion-hazardous environment, are connected to one another via Ethernet cables 120 over which data are transferred, and form an intrinsically safe sub-network 200.

A first network device 101 of the sub-network 200 is connected via an Ethernet cable 120 to the sixth network device 106 of the sub-network 200 and is supplied with electrical power via this Ethernet cable 120.

A second network device 102 of the sub-network 200 is connected via an Ethernet cable 120 to a third network device 103 of the sub-network 200 and is supplied with electrical power via this Ethernet cable 120.

The other network devices 103 to 106 of the sub-network 200 are each supplied with electrical power by an electrical energy source 130. In this arrangement an Ethernet cable 120, over which only data (but no electrical energy) are transmitted, connects the third network device 103 to a fourth network device 104, the fourth network device 104 to a fifth network device 105 and the fifth network device 105 to the sixth network device 106.

To implement the intrinsic safety of the sub-network 200, two network devices 101 to 106 of the sub-network 200 connected via an Ethernet cable 120 are connected to the Ethernet cable 120 in each case via special interfaces 141, 142, which have transmission devices 1 shown in FIG. 1 or 2. Also, first interfaces 141 for Ethernet connections over which only data (but no electrical power) are transmitted, have a transmission device 1 shown in FIG. 1 for each core pair of an Ethernet cable 120 connected thereto, wherein if required, the diodes 23 and/or isolating capacitors 9 are implemented redundantly, as described above. By contrast, second interfaces 142 for Ethernet connections over which both data and electrical power are transmitted have a transmission device 1 shown in FIG. 2 for each core pair of an Ethernet cable 120 connected thereto, wherein the diodes 23 and/or isolating capacitors 9 are again implemented redundantly if required, as described above.

The interfaces 141, 142 also each have a transceiver, which is connected via transceiver connections 13 to each transmission device 1 of the respective interface 141, 142. Each transmission device 1 then forms an output of an interface 141, 142 to an Ethernet cable 120.

The Ethernet network 100 is designed in such a way that over cores of Ethernet cables 120 which are connected to a transmission device 1 of the type shown in FIG. 2 (with, if necessary, redundant diodes 23 and/or isolating capacitors 9, see above), only data with data rates that are not less than a minimum data rate, for example 100 Mbit/s, are transmitted. In this case, the minimum data rate is specified in such a way as to correspond to intrinsically safe inductances of the coupling coils 25 and capacitances of the isolating capacitors 9 of a transmission device 1 of the type shown in FIG. 2. The coupling coils 25 and capacitances of the isolating capacitors 9 of the transmission devices 1 of the type shown in FIG. 2 are also designed intrinsically safe.

Network devices 107, 108 arranged outside of the intrinsically safe sub-network 200 are connected as far as possible via optical connections 150, which extend between optical interfaces 160, to network devices 101 to 106 of the intrinsically safe sub-network 200. In the Ethernet network 100 shown in FIG. 3, a seventh network device 107 is connected to the third network device 103 in this way and an eighth network device 108 is connected to the sixth network device 106 in this way. The seventh network device 107 and the eighth network device 108 are additionally connected via conventional Ethernet interfaces 170 and Ethernet cables 120 to a residual network 110, not shown in detail here, the components of which have no direct connection to network devices 101 to 106 of the sub-network 200.

The third network device 103, the sixth network device 106, the seventh network device 107 and the eighth network device 108 are each designed, for example, as a switch of the Ethernet network 100. The remaining network devices 101, 102, 104, 105 shown are each designed, for example, as a terminal of the Ethernet network 100.

It is essential to the implementation of the intrinsic safety of the Ethernet network 100 that the sub-network 200 contains no conventional Ethernet interfaces 170, but only interfaces 141, 142 with outputs implemented by transmission devices 1 and optical interfaces 160 may be used for Ethernet connections. It is also essential that all transmission devices 1 of the type shown in FIG. 2 (with, if necessary, redundant diodes 23 and/or isolating capacitors 9, see above) are designed intrinsically safe, which is facilitated by the fact that they are only used for cores over which data are transmitted at data rates not less than the minimum data rate and, in particular, no auto-negotiation is performed.

Transmission devices 1 of the type shown in FIG. 1 (with, if necessary, redundant diodes 23 and/or isolating capacitors 9, see above) by contrast, can also be used for cores over which data are transmitted at data rates that are below the minimum data rate and in particular, auto-negotiation is routed, since these transmission devices 1 have no coupling coils 25 for coupling in electrical energy.

The intrinsic safety of the Ethernet network 100 is achieved by the fact that for Ethernet connections to be designed intrinsically safe, two different types of transmission devices 1 are used, namely a transmission device 1 of the type shown in FIG. 1 for Ethernet connections over which only data are transferred, and a transmission device 1 of the type shown in FIG. 2 for Ethernet connections over which energy is additionally transferred, wherein a minimum data rate for data transmissions is provided for these Ethernet connections to which the transmission device 1 of the type shown in FIG. 2 is matched.

Although the invention has been illustrated and described in greater detail by means of preferred exemplary embodiment, the invention is not restricted by the examples disclosed and other variations can be derived therefrom by the person skilled in the art without departing from the scope of protection of the invention.

### LIST OF REFERENCE NUMERALS

1 transmission device
3, 5 sub-path
7 current limiting resistor
9 isolating capacitor
11 common-mode rejection unit
13 transceiver connection
15 choke coil
17 current-compensated choke
19, 21 diode current branch
23 diode
25 coupling coil
27 coupling connection
100 Ethernet network
101 to 108, network device
110 residual network
120 Ethernet cable
130 electrical energy source
141, 142 interface
150 optical connection
160 optical interface
170 conventional Ethernet interface
200 sub-network

1.-13. (canceled)

14. A transmission device for intrinsically safe data transmission in an Ethernet network using a core pair of an Ethernet cable, said transmission device comprising
a first sub-path of an Ethernet signal pair connected to a first core of the core pair; and
a second sub-path of an Ethernet signal pair connected to a second core of the core pair, each sub-path having at least one current-limiting resistor and a common-mode rejection unit that is connected in series with the current limiting resistor.

15. The transmission device of claim 14, wherein each sub-path has at least one isolating capacitor, which is connected in series with the common mode rejection unit and the at least one current limiting resistor.

16. The transmission device of claim 15, wherein each isolating capacitor has a capacitance such that data transmission is intrinsically safe and the signal flow that transmits the data is not obstructed by the impedance of the isolating capacitor.

17. The transmission device of claim 14, wherein each common-mode rejection unit is designed as a winding assembly that has one of two choke windings of a current-compensated choke and two diode current branches connected in parallel with the choke winding, wherein the two diode current branches of each winding assembly each have at least one diode, so that the two diode current branches have different blocking directions for electric current.

18. The transmission device of claim 14, wherein each sub-path is connected to a coupling coil by which electrical energy can be coupled into the core connected to the sub-path or can be coupled out from the core connected to said sub-path.

19. The transmission device of claim 18, wherein each coupling coil has an inductance which has at least a minimum inductance so that the coupling coil does not load data signals that are transmitted, and does not exceed a maximum inductance so that the data transmission is intrinsically safe.

20. An Ethernet network, comprising:
a network device;
an Ethernet cable having a core pair; and
a transmission device configured to electrically connect the network device to the core pair of the Ethernet cable in an explosion-hazardous environment, said transmission device including a first sub-path of an Ethernet signal pair connected to a first core of the core pair, and a second sub-path of an Ethernet signal pair connected to a second core of the core pair, each sub-path having at feast one current-limiting resistor and a common-mode rejection unit that is connected in series with the current limiting resistor.

21. The Ethernet network of claim 20, wherein only data is transmitted over the Ethernet cable between said network device and another network device, and each core of the Ethernet core pair is connected to a respective one of said network devices by a respective transmission device.

22. The Ethernet network of claim 20, wherein both data and electrical energy are transmitted over the Ethernet cable between said network devices and each end of each core of said core pair is connected to said network devices by respective transmission devices.

23. The Ethernet network of claim 20, wherein each sub-path is connected to a coupling coil configured to couple electrical energy into or out from the core connected to said sub-path, wherein the inductance of each coupling coil of the transmission device depends on a data rate at which the transmission device transmits data.

24. The Ethernet network of claim 20, further comprising at least one of BroadR-Reach functionality or Long-Distance Ethernet functionality or 2-wire Ethernet functionality.

25. An intrinsically safe method of transmitting data from a first network device to a second network device in an Ethernet network having an Ethernet core pair, the first network device being connected to a first sub-path of an Ethernet signal pair that is connected to a first core of the Ethernet core pair and to a second sub-path of the Ethernet signal pair that is connected to a second core of the Ethernet core pair, wherein each sub-path has at least one current-limiting resistor and a common-mode rejection unit that is connected in series with the current limiting resistor, comprising:
connecting the first network device to the second network device in an Ethernet network over an Ethernet core pair having a respective first and second sub-path, each sub-path having at least one current-limiting resistor and a common-mode rejection unit that is connected in series with the current limiting resistor; and
transmitting data between the first network device and the second network device over said Ethernet core pair that is connected by the sub-paths to the network devices without transmitting data for a preliminary auto-negotiation step over said Ethernet core pair.

26. The method of claim 25 wherein the first and second network devices are each connected to the Ethernet core pair using a respective first and second sub-path that each have a coupling coil connected thereto, further comprising the step of coupling electrical energy through the respective core connected to each sub-path using a respective coupling coil.

27. The method of claim 26 wherein the first and second network devices are each connected to the Ethernet core pair using a respective first and second sub-path that each have a coupling coil, further comprising the step of selecting a coupling coil that has an inductance that is not less than a minimum inductance, such that the coupling coil does not load data signals, and that does not exceed a maximum inductance, such that the data transmission is intrinsically safe.

28. The method of claim 25, wherein all data is transmitted between the first network device and the second network device over said Ethernet core pair connected to the respective network devices by respective transmission devices at a data rate that is less than a specified minimum data rate.
